(19) United States
(12) Patent Application Publication
(10) Pub. No.: US 2006/0197655 A1
(43) Pub. Date: Sep. 7, 2006

(54) Batteryless tire pressure monitoring system

(76) Inventors: Yi Luo, Ypsilanti, MI (US); Qingfeng Tang, Novi, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/064,642

(22) Filed: Feb. 24, 2005

(51) Int. Cl. B60C 23/00; G08B 23/00

(52) U.S. Cl. 340/447; 340/693.1

(57) ABSTRACT

A batteryless tire pressure sensing device is provided that includes a sensor disposed in a wheel for sensing at least one pressure-related parameter of a tire. An antenna is coupled to the sensor for receiving a modulated microwave energy signal. A control circuit coupled to the antenna and the sensor converts at least a portion of the modulated microwave energy signal to a supply voltage for providing power to the sensor. The sensor senses the at least one pressure related parameter of the tire in response to receiving the supply voltage from the control circuit.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

This invention relates in to a tire pressure monitoring system, and more specifically, to a batteryless tire pressure sensor monitoring system.

2. Description of the Related Art

Tire pressure monitoring (TPM) systems include disposing pressure sensors on or within vehicle tires to sense the pressure within a respective tire and report low or high pressure conditions to a driver. Various systems have mounted sensors inside the tires on a portion of the rubber, the rim of the wheel, on a valve stem within a wheel, or on the valve stem outside of the wheel. TPM systems sense tire pressure within a tire and transmit a signal to a body-mounted receiving unit located external to the tire for processing tire pressure data. A power source is required to energize the sensor and other electrical components of the TPM system within the tire. Other electrical devices may include a transmitter if the data sensed is being wirelessly transmitted to a nearby receiver. Many TPM systems utilize a battery as the power source for energizing the electrical components within the TPM system. However, typical storage batteries have a finite life and require periodic replacement. The longer the activation time of a respective TPM to measure and report pressure values, the shorter the useful life of a respective battery. For TPM sensors located external to the tire, batteries may be easily replaced or recharged. However, TPM systems incorporating TPM systems external to tire are directly exposed to and affected by exterior environment conditions and road conditions.

For TPM systems located internally to the tire and utilizing a battery as the power source, these systems typically require dismounting the tire from the vehicle and removing the tire from the rim to access the TPM sensor for replacing or recharging the battery. This requires cost, time, and effort.

Systems utilizing T?M sensors internal to the tire typically place the TPM electronics into a dormant state when not in use and activate the TPM system only when needed so as to conserve energy and extend the life of the battery. However, this only extends the life of the finite power source and at some future point in time requires changing the battery. What would be useful is a maintenance free TPM system that includes a power source which requires neither replacement nor recharging.

### SUMMARY OF THE INVENTION

The present invention has the advantage of mounting a batteryless tire pressure sensing device on a vehicle wheel and transmitting a microwave energy signal to the tire pressure sensing device for powering a sensor within the tire pressure sensing device for retrieving at least one pressure related parameter. A signal containing the sensed pressure related parameter portion is modulated with a portion of the received microwave energy signal and transmitted to a reading module disposed within the vehicle.

In one aspect of the present invention, a batteryless tire pressure sensing device is provided that includes a sensor disposed in a wheel for sensing at least one pressure-related parameter of a tire. An antenna is coupled to the sensor for receiving a modulated microwave energy signal. A control circuit coupled to the antenna and the sensor converts at least a portion of the modulated microwave energy signal to a supply voltage for providing power to the sensor. The sensor senses the at least one pressure related parameter of the tire in response to receiving the supply voltage from the control circuit.

### BRIEF DESCRIPTION OF THE DRAWINGS

FIG. 1 is an exploded vehicle illustration including a tire pressure monitoring system according to a preferred embodiment of the present invention.

FIG. 2 is a circuit diagram of the tire pressure monitoring system according to the preferred embodiment of the present invention.

FIG. 3 is a flow chart for powering a tire pressure sensor in a vehicle wheel according to the first preferred embodiment of the present invention.

### DETAILED DESCRIPTION OF PREFERRED EMBODIMENTS

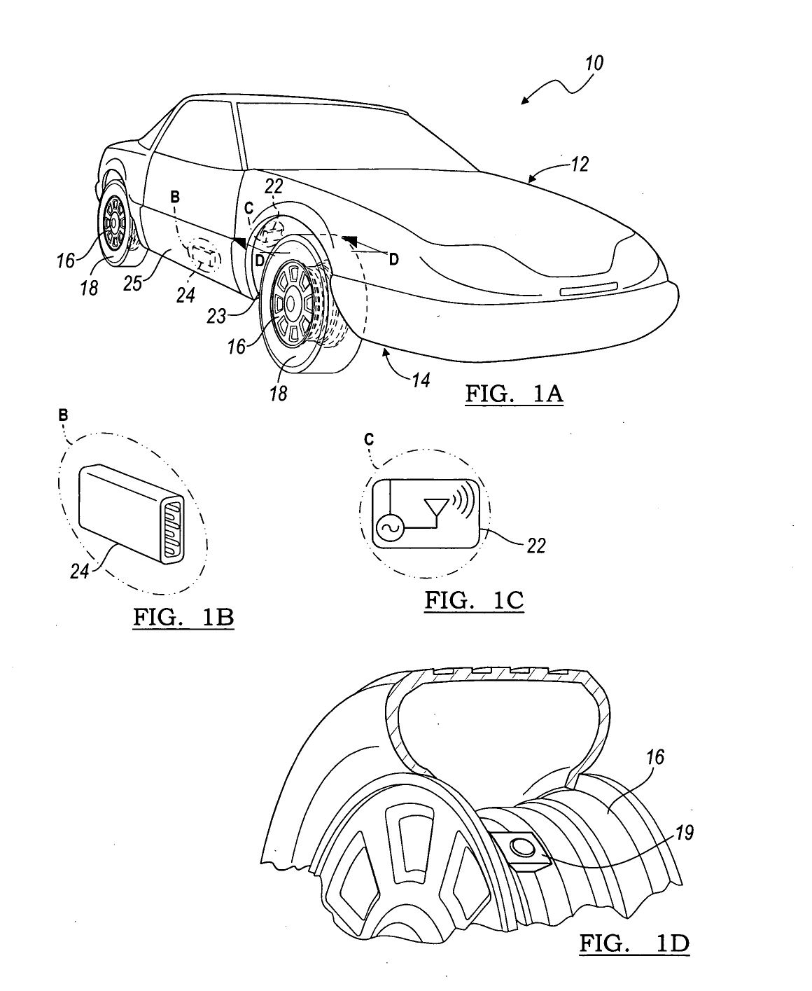

Referring now to the Drawings and particularly to FIG. 1 there is shown a vehicle 10 illustrating an exploded view of a tire pressure monitoring (TPM) system in accordance with the present invention. The vehicle 10 includes a vehicle body 12 mounted on a vehicle chassis 14 or unibody. The chassis 14 includes a set of axles (not shown) that are coupled to a respective pair of wheels 16 and tires 18. The vehicle tires 18 are pneumatic such that they are filled with compressed air or other gas to a respective internal air pressure. The internal air pressure of each tire exerts an outward force on the inner surface of the each tire for supporting the vehicle 10. A seal is formed between the tire and a rim of the respective wheel so that internal air pressure can be maintained within the tire.

To monitor the internal air pressure of an inflated tire without having to manually couple an air gauge measurement device to a valve stem of the wheel, a tire pressure sensor is coupled to a respective vehicle wheel for automatically measuring the internal air pressure of the respective tire. The tire pressure sensor monitors the respective vehicle tire for a high or low pressure condition. Other pressure related parameters such as temperature may also be monitored. The pressure related measurements are transmitted via a wireless signal to a receiving unit within the vehicle. The receiving unit receives the tire pressure measurements and when a low or high pressure condition is detected, a warning indicator is provided to the driver of the vehicle informing the driver of the respective condition.

A tire pressure sensing device 19 is affixed to the inside of a wheel 16 to monitor the inflation pressure of a tire 18. Various methods may be used to attach the tire pressure sensing device 19 to the wheel 16 of the vehicle 10 such as bolting the tire pressure sensing device 19 to the interior surface of the wheel 16, strapping the tire pressure sensing device 19 about the inside circumference of the wheel 16, or mounting the tire pressure sensing device 19 to a valve stem. Since the tire pressure sensing device 19 is sealingly contained within the rotating wheel 16 and tire 18, it is difficult to provide power a wireline from the fixedly-mounted reading module 22 via to the tire pressure sensing device 19. In the present embodiment, the reading module 22 provides power to the sensor 26 by transmitting a microwave energy signal to the tire pressure sensing device 19 disposed within the wheel 16.

The reading module 22 is mounted to the interior of the vehicle body 12 on an opposing side of a vehicle wheel well 23 for being in close proximity to tire pressure sensing device 19. Power level emissions of transmitted signals are limited as the Federal Communications Commission (FCC) maintains regulations on the maximum emission that may be generated by a respective transmitted signal for a respective application. As a result, it is advantageous to mount the reading module 22 in close proximity to the respective wheel so that a signal may be transmitted utilizing an optimum transmission power level in compliance with FCC regulations while minimizing the amount of energy dissipated during the energy signal transmission. The tire pressure sensing device 19 converts at least a portion of the microwave energy signal to a supply voltage that powers a sensor 26 within the tire pressure sensing device 19. Typically the sensor 26 operates on a voltage range of 1.7-5 volts; however, other sensors may be utilized which require voltages outside of the preferred operating range. The tire pressure sensing device 19 senses at least one pressure related-parameter. The sensed pressure related-parameter data is transmitted to the reading module 22. The reading module 22 demodulates the pressure related-parameter signal and provides pressure related-parameter data to an electronic control unit 24 for generating a control action in response to the pressure related-parameter data. Alternatively, the reading module 22 and the electronic control module 24 may be integrated into a single module. Preferably, the electronic control unit 24 is disposed in the interior portion of a door panel 25 or instrument panel (not shown). For complexity and cost reduction reasons, the electronic control unit 24 may be integrated with another control module such as a remote keyless entry module (not shown).

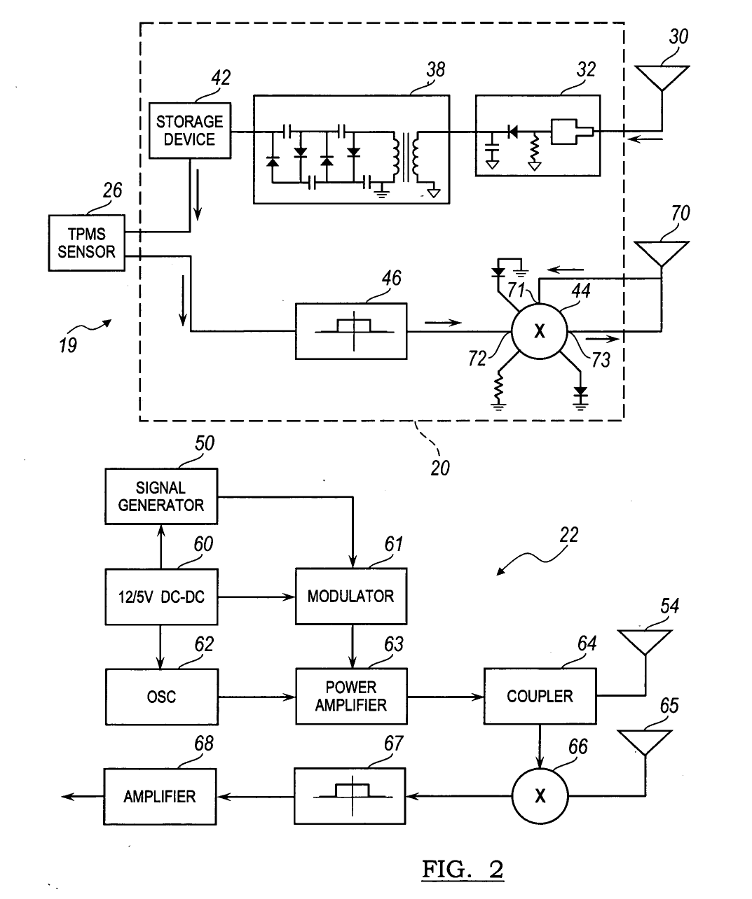

FIG. 2 shows a circuit diagram of the TPM system according to a preferred embodiment of the present invention. The reading module 22 transmits the modulated microwave energy signal for powering the tire pressure sensing device 19. The reading module 22 includes a signal generator 50 for generating a microwave energy signal (fₘ). A DC voltage supply device 60 inputs a DC supply voltage into a signal generator 50 for powering the signal generator 50. The microwave energy signal (fₘ) generated by the signal generator 50 is input to a modulator 61 for modulating the microwave energy signal. Preferably, the microwave energy signal is amplitude modulated using amplitude shift keying. The modulated microwave signal is provided to a power amplifier 63 where the signal is amplified and mixed with a carrier signal (5.8 GHz) from a local oscillator 62 (or a voltage controlled oscillator) to generate a transmittable energy signal (f_{c}±fₘ). The DC voltage supply device 60 powers both the local oscillator 62 and the modulator 61. The transmittable energy signal (f_{c}±fₘ) is then input to a coupler 64. The transmittable energy signal (f_{c}±fₘ) is transmitted via a patch antenna 54 to the tire pressure sensor device 19. The transmittable energy signal (f_{c}±fₘ) may include an identification code for identifying the energy signal as it is received by the tire pressure sensing device 19.

The tire pressure sensing device 19 includes an antenna 30 for receiving the transmittable energy signal (f_{c}±fₘ), a control circuit 20 for transforming transmittable energy signal (f_{c}±fₘ) to DC voltage, and the sensor 26 for measuring the pressure related parameters of a respective vehicle tire. The transmittable energy signal (f_{c}±fₘ) is received via the antenna 30 at a power level of −12˜−2 dBm and is input to an envelope detector 32 such as a diode detector that forms a homo-dyne receiver. The envelope detector 32 includes an impedance matching device and diode with a resistor and capacitor connected in parallel from the input and output, respectively, to ground. Alternatively, a transceiver may be used for receiving the transmittable energy signal. The carrier signal (f_{c}) is removed by the envelope detector and the microwave energy signal (fₘ) is then input to a voltage double rectifier 38 for converting the voltage of the microwave energy signal to a higher voltage level and for rectifying the microwave energy signal (fₘ) to a DC supply voltage. Alternatively, a separate rectifier and transformer may be used. In addition, only a rectifier may be required if the microwave energy signal (fₘ) received is of a voltage level that is sufficient to power the sensor 26 without having to boost the voltage level. The DC supply voltage is input to an energy storage device 42 but this is only necessary if the supply voltage output from the double voltage rectifier 38 is not sufficient to power the sensor 26. The sensor 26 is energized when the accumulated energy in the energy storage device 42 is sufficient to provide a continuous flow of energy to the sensor 26 for a predetermined duration of time to measure the pressure related parameters. When the sensor 26 is energized, the sensor 26 measures the pressure related parameters (e.g., pressure and temperature) of the pressurized air within the tire 18.

After the pressure and temperature parameters are measured by the sensor 26, the pressure related parameter data is digitized and is provided to a low pass filter 46. The sensor 26 is capable of generating high frequencies in the range of 10-20 kHz. The low pass filter 46 is required to filter the high frequencies generated by the sensor 26. Furthermore, the low pass filter 46 is used to block the 5.8 GHz signal generated by the mixer 44 from propagating to the sensor 26. In alternative embodiments, other sensors may be utilized which generate lower frequencies that do not require filtering or are not sensitive to high frequencies. The pressure related parameter data is then output to a mixer 44. The tire pressure sensing device 19 may include a second antenna 70 coupled to a first port 71 of the mixer 44 for receiving a portion of the transmittable energy signal (f_{c}±fₘ) where it is then combined in the mixer 44 with the data signal (fₛ) input from a second port 72. Alternatively, a portion of the transmittable energy signal (f_{c}±fₘ) received in antenna 30 may have been provided to the first port 71 of the mixer 44 for combining with the data signal (fₛ) as opposed to utilizing the second antenna 70. The combined data signal (f_{c}±fₘ±fₛ) is then output from the mixer via port 73 and transmitted to the reading module 22 and is received by antenna 65. Alternatively, the reading module may utilize only one antenna receiving and transmitting incoming and outgoing signals, respectively. Furthermore, a 2-port mixer may be utilized where the energy received from a respective antenna is input to the mixer via a respective port and is then mixed with a data signal and output the same respective port for transmitting to the reading module. Alternatively, a transceiver may be used to transmit the signal to the reading module.

The combined data signal (f_{c}±fₘ±fₛ) received by antenna 65 is input to a mixer (i.e., down converter). The coupler 64 directs the carrier signal (f_{c}) to the mixer 66 for filtering the carrier signal (f_{c}) from the received combined data signal (f_{c}±fₘ±fₛ). The output of the mixer 66 (fₘ±fₛ) is input to a low pass filter 67 where the data signal (fₛ) is filtered from the output signal (fₘ±fₛ) of the mixer 66. The data signal (fₛ) is input to an amplifier 68 for increasing the signal strength and then transmitted to the electronic control module 24 (shown in FIG. 1) for performing a control action in response to the pressure related parameter data. Alternatively, the reading module 22 and the electronic control module 24 may be integrated into a single housing.

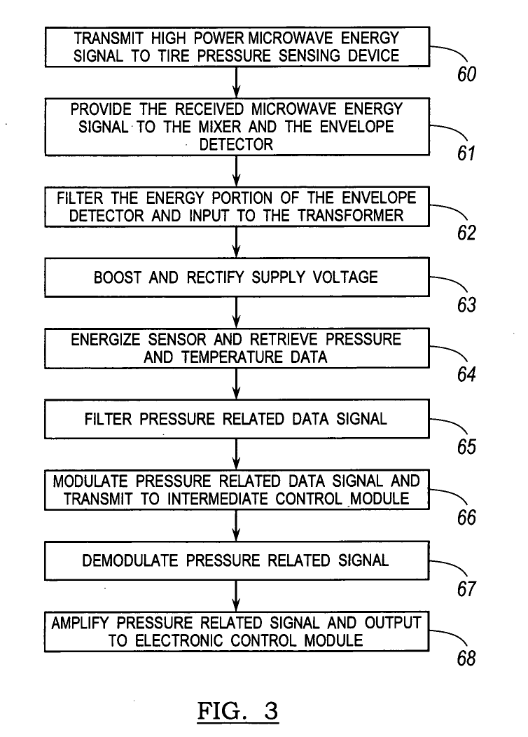

FIG. 3 illustrates a flowchart for energizing a tire pressure sensing device mounted in a wheel of a vehicle. In step 60, a high power modulated microwave energy signal is transmitted to the tire pressure sensing device from a transceiving device such as the reading module. The microwave energy signal is received by tire pressure sensing device. In step 61, a portion of the microwave energy signal is input to the mixer of the tire pressure sensing device and the other portion is input to the envelope detector for filtering the energy portion of the received microwave energy signal. In step 62, the microwave energy signal is filtered and the energy signal is input to the transformer of the tire pressure sensing device. In step 63, the energy signal is boosted to a higher voltage and is then provided to a power transfer device for rectifying the A/C supply voltage to a DC supply voltage. Optionally, the DC supply voltage may be stored in an energy storage device until the stored supply voltage is at a voltage level sufficient to continuously energize the sensor for a duration of time to perform the pressure related measurements.

In step 64, the sensor is energized by the DC supply voltage. Pressure related parameter data, such as pressure and temperature within a respective vehicle tire, is measured. In step 65, the pressure related parameter data is input to a low pass filter for filtering high frequencies generated by the sensor. In step 66, pressure related parameter data is input to a mixer where it is mixed with the portion of the modulated microwave energy signal provided to the mixer. The modulated data signal is transmitted to the reading module. In step 67, the pressure related parameter data is demodulated from the received data signal. In step 68, the pressure related parameter data is amplified and is then output to the electronic control module for performing a control action in response to the pressure related parameter data.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A batteryless tire pressure sensing device comprising:
a sensor disposed in conjunction with a wheel for sensing at least one pressure-related parameter of a tire;
an antenna coupled to said sensor for receiving a microwave energy signal; and
a control circuit coupled to said antenna and said sensor for converting at least a portion of said microwave energy signal to a supply voltage for providing power to said sensor;
wherein said sensor senses said at least one pressure related parameter of said tire in response to receiving said supply voltage from said control circuit.

2. The batteryless tire pressure sensing device of claim 1 further comprising a transceiver coupled to said antenna and said control circuit for receiving said microwave energy signal via said antenna and for transmitting said at least one pressure related parameter to a reading module disposed in a vehicle.

3. The batteryless tire pressure sensing device of claim 1 wherein said control circuit includes an envelope detector coupled to said antenna filtering said energy portion of said received microwave energy signal.

4. The batteryless tire pressure sensing device of claim 3 wherein said control circuit includes a transformer coupled to said envelope detector for increasing said supply voltage provided to said sensor.

5. The batteryless tire pressure sensing device of claim 1 wherein said control circuit includes a rectifier for rectifying said supply voltage provided to said sensor.

6. The batteryless tire pressure sensing device of claim 1 wherein said at least one pressure-related parameter includes a gas pressure within said tire.

7. The batteryless tire pressure sensing device of claim 1 wherein said at least one pressure-related parameter includes a gas temperature within said tire.

8. The batteryless tire pressure sensing device of claim 1 wherein said sensor is mounted on said wheel internally in relation to said tire.

9. A batteryless tire pressure monitoring system comprising:
a reading module for transmitting a microwave energy signal;
a sensor disposed in a wheel for sensing at least one pressure-related parameter of said tire;
a transceiver coupled to said sensor for receiving said microwave energy signal and for transmitting a modulated tire pressure-related signal; and
a control circuit coupled to said transceiver and said sensor for demodulating said microwave energy signal and for converting at least a portion of said microwave energy signal to a supply voltage for providing power to said sensor;
wherein said sensor senses said at least one pressure-related parameter of said tire in response to receiving said supply voltage from said control circuit and said transceiver transmits said tire-pressure related signal containing said sensed pressure-related parameter to said reading module.

10. The batteryless tire pressure sensing system of claim 9 wherein said control circuit includes a transformer coupled to said antenna for increasing said supply voltage provided to said sensor.

11. The batteryless tire pressure sensing system of claim 9 wherein said control circuit includes a rectifying device coupled to said transformer for rectifying said supply voltage provided to said sensor.

12. The batteryless tire pressure sensing system of claim 9 further comprising a vehicle-based electrical control unit for receiving said sensed pressure related parameter from said reading module and for generating a control action in response to said sensed pressure relate parameter.

13. A method for providing electrical energy to a tire pressure sensing device including a sensor for sensing at least one pressure related parameter of a vehicle tire, the method comprising the steps of:
transmitting a modulated microwave energy signal to said tire pressure sensing device;
converting at least a portion of said modulated microwave energy signal to a supply voltage; and
applying said supply voltage to said sensor;
determining a pressure-related parameter; and
transmitting said pressure-related parameter to a reading module.

14. The method of claim 13 further comprising the step of transforming said supply voltage to a higher supply voltage for powering said sensor.

15. The method of claim 13 for them comprising the steps of rectifying said supply voltage for powering said sensor.

16. The method of claim 13 further comprising the step of providing a second portion of said modulated microwave energy signal to a mixer for combining with a signal that includes said pressure related parameter for transmitting said pressure related parameter to reading module.

17. The method of claim 13 further comprising the step of transmitting said pressure-related parameter to an electrical control unit for providing a control action in response to said pressure-related parameter.

18. The method of claim 17 wherein said control action includes providing a visual warning regarding said pressure related parameter.

19. The method of claim 17 wherein said control action includes providing an audible warning regarding said pressure related parameter.

20. The method of claims 17 wherein said control action includes a status indicator of said pressure related parameter.
